(19) United States
(12) Patent Application Publication
(10) Pub. No.: US 2025/0332579 A1
(43) Pub. Date: Oct. 30, 2025

(54) SUPPORTED MEDIUM ENTROPY ALLOYS FOR HYDROGEN PRODUCTION FROM NATURAL GAS

(71) Applicant: Saudi Arabian Oil Company, Dhahran (SA)

(72) Inventors: Xiaoxing Wang, Richmond, TX (US); Feng Liang, Houston, TX (US)

(21) Appl. No.: 18/650,758

(22) Filed: Apr. 30, 2024

(51) Int. Cl. B01J 23/889; B01J 21/04; B01J 35/30; B01J 35/45; B01J 37/00; B01J 37/02; B22F 9/04; C01B 3/26; C01B 3/50; C22C 30/00; C22C 33/02; C22C 38/04

(52) U.S. Cl. CPC B01J 23/8892; B01J 21/04; B01J 35/394; B01J 35/45; B01J 37/0036; B01J 37/0223; B22F 9/04; C01B 3/26; C01B 3/501; C22C 30/00; C22C 33/0278; C22C 38/04; B22F 2009/041; B22F 2009/043; B22F 2301/00; B22F 2301/35; B22F 2998/10; B22F 2999/00; C01B 2203/0277; C01B 2203/0405; C01B 2203/1011; C01B 2203/1058; C01B 2203/1082; C01B 2203/1241; C01B 2203/1676

(57) ABSTRACT

Compositions and methods for the catalysis of methane pyrolysis. Compositions include a catalyst system that includes a medium entropy alloy particle and a support. Methods include catalyzing the pyrolysis of methane using the catalyst system.

### TECHNICAL FIELD

This document relates to catalyst systems that include a medium entropy alloy particle and a support, and the catalysis of methane pyrolysis to produce hydrogen gas.

### BACKGROUND

The rapid increase of CO₂ levels in the atmosphere is regarded as a primary cause of global climate change. One promising way to address this problem is to switch to clean energy, using a clean fuel such as hydrogen. Currently, hydrogen can be produced using methane steam reforming, (MSR), coal gasification processes, partial oxidation of methane (POM), autothermal reforming of methane (ATR), dry reforming of methane (DRM), and tri-reforming (H₂O, CO₂, and methane). However, all of these processes emit large amounts of CO₂. Alternatively, hydrogen can be produced by catalytic methane pyrolysis (CMP, Eq. 1). CMP can produce CO₂-free and/or low-CO₂ emission hydrogen, as well as valuable solid carbon products such as amorphous carbon, carbon nanotubes, and nanofibers.

$$C {H}_{4} {↔}_{cat} C + 2 {H}_{2} \qquad Eq . 1$$

Methane pyrolysis is an endothermic reaction and high temperatures are normally required in the absence of a catalyst. Many different types of catalysts have been developed for methane pyrolysis processes, including metal and carbon-based catalysts. Compared to carbon-based catalysts, metal catalysts are more active and work at a lower temperature, but typically suffer quick deactivation due to metal sintering, carbon encapsulation and metal migration.

One of the challenges of using an MEA alone as the catalyst in a fixed-bed reactor is that carbon deposit over the catalyst surface can deactivate the catalyst by covering the active sites and/or forming strong bonding, which can impede methane conversion. Additionally, MEAs are also prone to agglomeration and have sintering problems at high reaction temperatures, causing either the conversion rate to decrease over time, or plugging the gas flow channel.

### SUMMARY

This disclosure describes catalyst systems that include a medium entropy alloy particle and a support, as well as the use of the catalyst systems to catalyze methane pyrolysis for hydrogen production.

In some embodiments, a catalyst system includes a medium entropy alloy (MEA) particle, wherein the MEA particle includes a first principal metal, a second principal metal, and a third principal metal, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be. The catalyst system includes a support, wherein the support includes a metal oxide, mixed oxide, carbon material, or metal organic framework.

In some embodiments, a method of producing a catalyst system includes lacing a first principal metal, a second principal metal, and a third principal metal, a support, and zirconia media in a ball mill, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be, and wherein the support includes a metal oxide, mixed oxide, carbon material, or metal organic framework; rotating the ball mill to produce the catalyst system; and separating the produced catalyst system from the zirconia media.

In some embodiments, a method of catalyzing methane pyrolysis includes loading a catalyst system into a reactor, wherein the catalyst system includes a medium entropy alloy (MEA) particle, wherein the MEA particle includes a first principal metal, a second principal metal, and a third principal metal, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be, and a support, wherein the support includes a metal oxide, mixed oxide, carbon material, or metal organic framework; heating the reactor; introducing a feedstock and a carrier gas to the reactor, wherein the feedstock includes methane and wherein the carrier gas includes an inert gas; and catalyzing the pyrolysis of the methane using the catalyst system to produce hydrogen gas.

The details of one or more embodiments of the disclosure are set forth in the accompanying drawings and the description that follows. Other features, objects, and advantages of the disclosure will be apparent from the description and drawings, and from the claims.

### DESCRIPTION OF DRAWINGS

FIG. 1 is a flow chart of an example method of producing a catalyst system of the present disclosure by ball milling.

FIG. 2A shows an example schematic of a catalyst system of the present disclosure.

FIG. 2B shows an example schematic of a catalyst system of the present disclosure.

FIG. 3A shows an example schematic of a catalyst system that includes a catalyst promoter of the present disclosure.

FIG. 3B shows an example schematic of a catalyst system that includes a catalyst promoter of the present disclosure.

FIG. 3C shows an example schematic of a supported MEA catalyst with three principal metals that includes a catalyst promoter in the MEA particles.

FIG. 3D shows an example schematic of a supported MEA catalyst with three principal metals that includes a catalyst promoter both on a support and in the MEA particles.

FIG. 4A shows an example schematic of a catalyst system of the present disclosure that includes defects.

FIG. 4B shows an example schematic of a catalyst system of the present disclosure that includes defects.

FIG. 5A shows an example schematic of a catalyst system of the present disclosure that includes a catalyst promoter and defects.

FIG. 5B shows an example schematic of a catalyst system of the present disclosure that includes a catalyst promoter and defects.

FIG. 6 is a flowchart of an example method of the present disclosure of catalyzing methane pyrolysis.

FIG. 7 shows the percentage of CH₄ conversion over time in a methane pyrolysis reaction catalyzed by Al₂O₃ supported FeMn.

FIG. 8 shows the percentage of CH₄ conversion over time in a methane pyrolysis reaction catalyzed by Al₂O₃ supported FeMnNi.

FIG. 9 shows the percentage of CH₄ conversion over time in a methane pyrolysis reaction catalyzed by Al₂O₃ supported FeMnNiCo.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure are supported medium entropy alloys (MEAs), the synthesis of supported MEAs, and the use of supported MEAs as catalysts for effective zero-and/or low-CO₂ hydrogen production. MEAs have a configuration entropy between 1R and 1.5R. Configuration entropy can be calculated with the

$$- R {\sum }_{i = 1}^{n} {x}_{{M}_{i}} ln ( {x}_{{M}_{i}} ) ,$$

where S is configuration entropy, R is the gas constant, n is the type number of the constitute atoms and x_{M}_{ᵢ} is the mole fraction of the composition of atom Mᵢ. MEAs typically have near equimolar and non-equimolar alloys of three or four principal elements.

The MEAs described herein include three or four principal metal elements. The inclusion of three or four elements results in a better performing catalyst. MEAs can be used to produce hydrogen from natural gas at elevated temperatures, thus providing an efficient utilization of natural gas in a sustainable way. A catalyst support can prevent agglomeration and sintering issues. Further, with a support, the particle size of MEAs can be controlled in a suitable manner for hydrogen production. Controlling the amount of metal over the support and variations in the preparation method can control the particle size of MEAs. A smaller amount of metal will yield a smaller particle. The supported MEA catalysts have high activity for methane conversion and good longevity for hydrogen production in methane pyrolysis reaction and/or alternative methane reforming processes.

The supported MEAs in this disclosure are referred to as a catalyst system. The catalyst system includes a catalyst support and MEA particles. The MEA particles include three or four principal metals. As described herein, MEA particles that include more than two, i.e., three or four principal metals, show improved performance in catalytic methane pyrolysis. For example, an MEA particle that includes at least three principal metals can have a higher initial and a higher overall methane conversion rate.

The MEA particles include three or four principal metals. The MEA particles include a first principal metal (M1), a second principal metal (M2), and a third principal metal (M3). In some embodiments, the MEA particles include a fourth principal metal (M4). The principal metals can be independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be. In other words, none of M1, M2, M3 are the same metal. For example, the MEA particles with three principal metals can be FeMnCo, FeMnNi, FeCoNi, FeCoCu, FeNiCu, MnCoNi, or CoNiCu, etc. In some embodiments, the MEA particle includes a fourth principal metal M4, and none of M1, M2, M3, or M4 are the same metal. The content of each principal metal can vary from about 1 atomic percent (at %) to about 90 at %. In some embodiments, the amount of each principal metal in the MEA particle varies from about 1 at % to about 80 at %, from about 1 at % to about 70 at %, from about 1 at % to about 60 at %, from about 1 at % to about 50 at %, from about 1 at % to about 40 at %, from about 1 at % to about 30 at %, from about 1 at % to about 20 at %, from about 1 at % to about 10 at %. In some embodiments, the amount of each principal metal in the MEA particle varies from about 10 at % to about 80 at %, from about 10 at % to about 70 at %, from about 10 at % to about 60 at %, from about 10 at % to about 50 at %, from about 10 at % to about 40 at %, from about 10 at % to about 30 at %, or from about 10 at % to about 20 at %. In some embodiments, each of the principal metals is present in an approximately equimolar amount. In some embodiments, the ratio of M1: M2: M3 is 1:1:1. In some embodiments, the ratio of M1: M2: M3: M4 is 1:1:1:1. In some embodiments, the MEA particles have a configuration entropy between 1R and 1.5R, where R is the gas constant.

In some embodiments, an MEA particle includes a first principal metal, where the first principal metal is Fe, a second principal metal, where the second principal metal is Mn, and a third principal metal, where the third principal metal is selected from the group consisting of: Ag, Au, Co, Cr, Cu, Ir, Mo, Ni, Pd, Pt, Re, Rh, Ru, Sn, Ti, V, W, Y, Zn, Zr, Al, Ga, In, Ce, Yb, and Be. In some embodiments, an MEA particle includes a first principal metal, where the first principal metal is Fe, a second principal metal, where the second principal metal is Mn, and a third principal metal, where the third principal metal is a transition metal selected from the group consisting of Ag, Au, Co, Cr, Cu, Ir, Mo, Ni, Pd, Pt, Re, Rh, Ru, Sn, Ti, V, W, Y, Zn, and Zr. In some embodiments, an MEA particle includes a first principal metal, where the first principal metal is Fe, a second principal metal, where the second principal metal is Mn, and a third principal metal, where the third principal metal is the alkaline earth metal Be. In some embodiments, an MEA particle includes a first principal metal, where the first principal metal is Fe, a second principal metal, where the second principal metal is Mn, and a third principal metal, where the third principal metal is a lanthanide selected from the group consisting of Ce and Yb. In some embodiments, an MEA particle includes a first principal metal, where the first principal metal is Fe, a second principal metal, where the second principal metal is Mn, and a third principal metal, where the third principal metal is selected from the group consisting of Al, Ga, and In. In some embodiments, an MEA particle with three principal metals includes a first principal metal, where the first principal metal is Fe, a second principal metal, where the second principal metal is Mn, and a third principal metal, where the third principal metal is Ni. In some embodiments, an MEA particle includes Fe, Mn, and Ni in a 1:1:1 atomic ratio.

In some embodiments, an MEA particle with three principal metals includes a first principal metal, where the first principal metal is Fe, a second principal metal, where the second principal metal is Mn, and a third principal metal, where the third principal metal is Co. In some embodiments, an MEA particle includes Fe, Mn, and Co in a 1:1:1 atomic ratio.

In some embodiments, an MEA particle with three principal metals includes a first principal metal, where the first principal metal is Fe, a second principal metal, where the second principal metal is Co, and a third principal metal, where the third principal metal is Ni. In some embodiments, an MEA particle includes Fe, Co, and Ni in a 1:1:1 atomic ratio.

In some embodiments, an MEA particle with three principal metals includes a first principal metal, where the first principal metal is Fe, a second principal metal, where the second principal metal is Co, and a third principal metal, where the third principal metal is Cu. In some embodiments, an MEA particle includes Fe, Co, and Cu in a 1:1:1 atomic ratio.

In some embodiments, an MEA particle with three principal metals includes a first principal metal, where the first principal metal is Fe, a second principal metal, where the second principal metal is Ni, and a third principal metal, where the third principal metal is Cu. In some embodiments, an MEA particle includes Fe, Ni, and Cu in a 1:1:1 atomic ratio.

In some embodiments, an MEA particle with three principal metals includes a first principal metal, where the first principal metal is Mn, a second principal metal, where the second principal metal is Co, and a third principal metal, where the third principal metal is Ni. In some embodiments, an MEA particle includes Mn, Co, and Ni in a 1:1:1 atomic ratio.

In some embodiments, an MEA particle with three principal metals includes a first principal metal, where the first principal metal is Co, a second principal metal, where the second principal metal is Ni, and a third principal metal, where the third principal metal is Cu. In some embodiments, an MEA particle includes Co, Ni, and Cu in a 1:1:1 atomic ratio.

In some embodiments, an MEA particle includes a first principal metal, where the first principal metal is Fe, a second principal metal, where the second principal metal is Ni, and a third principal metal, where the third principal metal is selected from the group consisting of: Ag, Au, Co, Cr, Cu, Ir, Mn, Mo, Pd, Pt, Re, Rh, Ru, Sn, Ti, V, W, Y, Zn, Zr, Al, Ga, In, Ce, Yb, and Be. In some embodiments, an MEA particle includes a first principal metal, where the first principal metal is Fe, a second principal metal, where the second principal metal is Ni, and a third principal metal, where the third principal metal is a transition metal selected from the group consisting of Ag, Au, Co, Cr, Cu, Fe, Ir, Mn, Mo, Ni, Pd, Pt, Re, Rh, Ru, Sn, Ti, V, W, Y, Zn, and Zr. In some embodiments, an MEA particle includes a first principal metal, where the first principal metal is Fe, a second principal metal, where the second principal metal is Ni, and a third principal metal, where the third principal metal is the alkaline earth metal Be. In some embodiments, an MEA particle includes a first principal metal, where the first principal metal is Fe, a second principal metal, where the second principal metal is Ni, and a third principal metal, where the third principal metal is a lanthanide selected from the group consisting of Ce and Yb. In some embodiments, an MEA particle includes a first principal metal, where the first principal metal is Fe, a second principal metal, where the second principal metal is Ni, and a third principal metal, where the third principal metal is selected from the group consisting of Al, Ga and In.

In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is selected from the group consisting of Ag, Au, Co, Cr, Cu, Ir, Mo, Pd, Pt, Re, Rh, Ru, Sn, Ti, V, W, Y, Zn, Zr, Al, Ga, In, Ce, Yb, and Be. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is a transition metal selected from the group consisting of Ag, Au, Co, Cr, Cu, Ir, Mo, Pd, Pt, Re, Rh, Ru, Sn, Ti, V, W, Y, Zn, and Zr. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is the alkaline earth metal Be. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is a lanthanide selected from the group consisting of Ce and Yb. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is selected from the group consisting of Al, Ga and In. In some embodiments, an MEA particle with four principal metals includes a first principal metal, where the first principal metal is Fe, a second principal metal, where the second principal metal is Mn, a third principal metal, where the third principal metal is Ni, and a fourth principal metal, where the fourth principal metal is Co. In some embodiments, the MEA particle includes Fe, Mn, Ni, and Co in a 1:1:1:1 atomic ratio.

Table 1 lists the first (M1), second (M2), and third (M3) principal metals of example MEA particles that include three principal metals. The MEA particles include three or four principal metals. In some embodiments, the ratio of the principal metals in the MEA particles listed in Table 1 is 1:1:1. Table 2 lists the first (M1), second (M2), third (M3), and fourth (M4) principal metals of example MEA particles that include four principal metals. In some embodiments, the ratio of the principal metals in the MEA particles listed in Table 2 is 1:1:1:1. Tables 1 and 2 are not limiting, and other non-repetitive combinations of the principal metals are possible. All of the MEA particles listed in Table 1 and Table 2 can be combined with support, catalysts promoters, and/or defects as described herein.

TABLE 1
Principal Metals of Example MEA particles

| M1 | M2 | M3 |
|---|---|---|
| Fe | Mn | Be |
| Fe | Mn | Ga |
| Fe | Mn | Ce |
| Fe | Mn | Yb |
| Fe | Mn | Al |
| Fe | Mn | Ag |
| Fe | Mn | Au |
| Fe | Mn | Co |
| Fe | Mn | Cr |
| Fe | Mn | Cu |
| Fe | Mn | Ir |
| Fe | Mn | Ni |
| Fe | Mn | Pd |
| Fe | Mn | Pt |
| Fe | Mn | Re |
| Fe | Mn | Rh |
| Fe | Mn | Ru |
| Fe | Mn | Sn |
| Fe | Mn | W |
| Fe | Mn | Zn |
| Fe | Mn | Zr |
| Fe | Ni | Be |
| Fe | Ni | Ga |
| Fe | Ni | Ce |
| Fe | Ni | Yb |
| Fe | Ni | Al |
| Fe | Ni | Ag |
| Fe | Ni | Au |
| Fe | Ni | Co |
| Fe | Ni | Cr |
| Fe | Ni | Cu |
| Fe | Ni | Ir |
| Fe | Ni | Mn |
| Fe | Ni | Pd |
| Fe | Ni | Pt |
| Fe | Ni | Re |
| Fe | Ni | Rh |
| Fe | Ni | Ru |
| Fe | Ni | Sn |
| Fe | Ni | W |
| Fe | Ni | Zn |
| Fe | Ni | Zr |
| Fe | Co | Ni |
| Fe | Co | Cu |
| Mn | Co | Ni |
| Co | Ni | Cu |

TABLE 2
Principal Metals of Example MEA particles

| M1 | M2 | M3 | M4 |
|---|---|---|---|
| Fe | Mn | Ni | Ga |
| Fe | Mn | Ni | Be |
| Fe | Mn | Ni | Ce |
| Fe | Mn | Ni | Yb |
| Fe | Mn | Ni | Al |
| Fe | Mn | Ni | Co |
| Fe | Mn | Ni | Cr |
| Fe | Mn | Ni | Cu |
| Fe | Mn | Ni | Zn |
| Fe | Mn | Ni | Zr |
| Fe | Mn | Ni | Ru |
| Fe | Mn | Ni | Rh |
| Fe | Mn | Ni | Pd |
| Fe | Mn | Ni | Ag |
| Fe | Mn | Ni | W |
| Fe | Mn | Ni | Re |
| Fe | Mn | Ni | Ir |
| Fe | Mn | Ni | Pt |
| Fe | Mn | Ni | Au |
| Fe | Mn | Ni | Sn |

The size of the MEA particle can vary from a few nanometers to micrometers in diameter. For example, the MEA particle can be from about 1 nm to about 10 μm in diameter or about 1 nm to about 1 μm in diameter. In some embodiments, the MEA particle is from about 1 n to about 1 μm in diameter, about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 200 nm, about 1 nm to about 100 nm, about 1 nm to about 90 nm, about 1 nm to about 80 nm, about 1 nm to about 70 nm, about 1 nm to about 60 nm, about 1 nm to about 50 nm, about 1 nm to about 40 nm, about 1 nm to about 30 nm, about 1 nm to about 20 nm, about 1 nm to about 10 nm, about 1 nm to about 5 nm, or about 1 nm to about 3 nm in diameter. In some embodiments, the MEA particle is from about 1 μm to about 10 μm, about 1 μm to about 9 μm, about 1 μm to about 8 μm, about 1 μm to about 7 μm, about 1 μm to about 6 μm, about 1 μm to about 5 μm, about 1 μm to about 4 μm, about 1 μm to about 3 μm, or about 1 μm to about 2 μm in diameter. The shape of the MEA particles can be spherical, square/cubic, triangle, or irregular. The MEA particles can include secondary phases such as intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite, or any combination thereof. In some embodiments, the secondary phase is a non-metallic phase present within the MEA particles as impurities or residues originating from catalyst precursors. For example, when a synthetic method for the MEA includes a reduction step of a metal oxide intermediate to a primary metallic phase, a small fraction of the oxide intermediate may remain in the product as the secondary phase. In some embodiments, the secondary phase does not exceed 5% of the mass of the MEA particle.

The support in the catalyst system can include metal oxides, mixed oxides, carbon materials or metal organic frameworks. The metal oxides can include Al₂O₃, SiO₂, TiO₂, ZrO₂, CeO₂, MgO, or MgAl₂O₃, or any combination thereof. The mixed oxides can include SiO₂—Al₂O₃, ZrO₂—Al₂O₃, CeO₂—Al₂O₃, ZrO₂—TiO₂, CeO₂—TiO₂, ZrO₂—SiO₂, or CeO₂—SiO₂, or any combination thereof. The carbon materials can include amorphous carbon, carbon black, activated carbon, graphene, graphene oxide, carbon nanotubes (CNTs), carbon nanofibers (CNFs), or graphite, or any combination thereof. Metal organic frameworks (MOF) can be used as the support. The pore structure and chemical composition of MOFs can improve the MEA dispersion and alloy interaction.

The type and composition of the catalyst support has an influence on the formation of MEA particles (i.e., the size, shape, and dimensions of the particles), the alloy-support interaction, sintering resistance, and adsorption of reactants. The support can make the MEA particles smaller, better dispersed, and more stable. The support can be considered as an adsorbent and metal ions are adsorbed on the support. Then metal ions combine together to form MEA which is still attached to the support via a chemical, physical and/or thermal process. In addition, the catalyst support is one of the key elements for preventing coke formation from coving the metal alloys on the surface of the catalyst. Accordingly, a supported catalyst remains active and stable during hydrogen production.

In some embodiments, the percent of a principal metal M1-M4 is 10% to 80% by weight.

In some embodiments, the catalyst system includes an MEA particle and a support, where the MEA particle includes a first, second, and third principal metal, the support includes aluminum oxide (Al₂O₃). In some embodiments, the first, second, and third principal metal and the support are in a 1:1:1:1 molar ratio. In some embodiments, the catalyst system includes an MEA particle and a support, where the MEA particle includes a first, second, third, and fourth principal metal, and the support includes Al₂O₃. In some embodiments, the first, second, third, and fourth principal metal and the support are in a 1:1:1:1:1 molar ratio.

In some embodiments, the catalyst system includes an MEA particle and a support, where the MEA particle includes a first principal metal, where the first principal metal is Fe, a second principal metal, where the second principal metal is Mn, and a third principal metal, where the third principal metal is Ni, and where the support includes Al₂O₃. In some embodiments, the catalyst system includes an MEA particle and support, wherein the MEA particle and support includes Fe, Mn, Ni, and Al₂O₃ in a 1:1:1:1 molar ratio. In some embodiments, the catalyst system includes an MEA particle and a support, where the MEA particle includes a first principal metal, where the first principal metal is Fe, a second principal metal, where the second principal metal is Mn, a third principal metal, where the third principal metal is Ni, and a fourth principal metal, where the fourth principal metal is Co, and where in the support includes Al₂O₃. In some embodiments, the catalyst system includes and MEA particle and support, where the MEA particle and support include Fe, Mn, Ni, Co, and Al₂O₃ in a 1:1:1:1:1 molar ratio.

In some embodiments, the support includes catalyst promoters. Catalyst promoters can be incorporated into the support by wet impregnation methods, or post-grafting methods. Catalyst promoters incorporated into the support can further improve the catalyst activity, hydrogen selectivity, catalyst stability, and tune the carbon growth mechanism so that the hydrogen production is operated in a continuous mode. A catalyst promoter can also strengthen the metal-support interaction, thus limiting segregation, coke formation, active oxidation, and metal migration and sintering.

A catalyst promoter can include a chemical promoter and/or a structural promoter. Chemical promoters improve the efficiency of the catalyst system by altering the distribution of electrons at the surface of the active catalyst. Chemical promoters also strengthen the interactions between the MEA particle and the support, making the catalyst more stable in the catalytic process. Structural promoters improve the mechanical properties of the catalyst system and prevent attrition when the catalyst system is used in fluidized-bed operations. In some embodiments, the catalyst promoter is both a chemical promoter and a structural promoter. In addition, catalyst promoters in the support can improve adsorption and offer chemisorption sites for reactants, thus improving the selectivity of the catalyst system and enhancing the efficiency and rate of reactions. Suitable catalyst promoters include alkali metals (Li, Na, Ca, K, Cs, Fr), Ce, CeₓO_{y} (e.g. Ce₂O₃, and CeO₂), Mg, MgO, Ca₂SiO₄, CaO, La, Nd, Ge, or Re, or any combination thereof.

In some embodiments, the support includes defects. In some embodiments, the defects on the support are created during the synthesis. The defects can include surface atom vacancy (e.g., oxygen vacancy, nitrogen vacancy, carbon vacancy), surface heteroatomic bonding (e.g., nitrogen bonding, oxygen bonding, carbon bonding), structure distortion, surface step, edge defects, stacking fault, or holes, or any combination thereof. The preferred size and dimensions of defects should match the atom size and dimensions of metal atoms loaded over the support, and the concentration of defects should be controlled to the optimized level depending on the type of defects and metal alloys applied.

Defects have a significant impact on the properties of the support material, such as the thermal, optical, magnetic and mechanical properties. Accordingly, the defects affect catalyst surface adsorption and desorption of reactants and products. Defect engineering is an important and effective strategy to improve catalytic activity of catalysts. The concentrations, distribution, and types of defects often have different influences on the activity of catalysts.

In some embodiments, the catalyst system includes a catalyst particles, support, and promoters. In some embodiments, the catalyst system includes catalyst particles, support, and defects in the support. In some embodiments, the catalyst system includes catalyst particles, support, promoters, and defects in the support.

### Synthesis and Characterization of Supported MEA Catalyst Particles

The supported MEA catalyst particles can be synthesized using wet-chemical methods, for example, impregnation, co-precipitation, solvothermal, or ultrasonicated-assisted wet-chemistry. The supported MEA catalyst particles can be synthesized using a salt precursor (e.g., nitrate) decomposition, followed by reduction to form an alloy. The supported MEA catalyst particles can by synthesized using sol-gel auto-combustion method, spray pyrolysis, carbothermal shock synthesis, hydrothermal method, pulse-laser ablation, mechanical milling, mechanical alloying, arc melting, induction melting, metal spray technique, molecular beam epitaxy (MBE), atomic layer deposition (ALD), chemical vapor deposition (CVD), or pulsed laser deposition (PLD).

The supported MEA catalyst particles can be synthesized by mechanical mill, for example, ball milling. In a ball milling procedure, an amount of the three principal metals and support, and optionally a fourth principal metal, are placed in a ball mill along with zirconia media. In some embodiments the molar ratio of each of the individual principal metals to the support is 1:1. The zirconia media includes zirconia particles with a diameter between 0.5 and 10 mm. For example, the zirconia media can include particles with a diameter of 1 mm, or 3 mm. In some embodiments, the ball milling process utilizes more than one size of zirconia media, for example 1 mm and 3 mm media. The ball mill is then rotated at room temperature for a period of time sufficient to produce the catalyst system. For example, the ball mill can be rotated for 1-5 days. In some embodiments, the ball mill is rotated for 2 days. The ball mill is rotated at a speed of about 500 to about 2000 rpm, for example, about 1100 rpm. The resulting catalyst powder is then separated from the zirconia media and collected. In some embodiments, the powder is separated from the zirconia media by sieving/filtering through a fine mesh screen.

In some embodiments, the supported MEA catalyst particles can include a primary phase and a secondary phase. The primary phase is the metal alloy including the principal metals M1-M3 or M1-M4. The secondary phase can include intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite. The secondary phases can be introduced into the supported MEA catalyst particles during the catalyst preparation process.

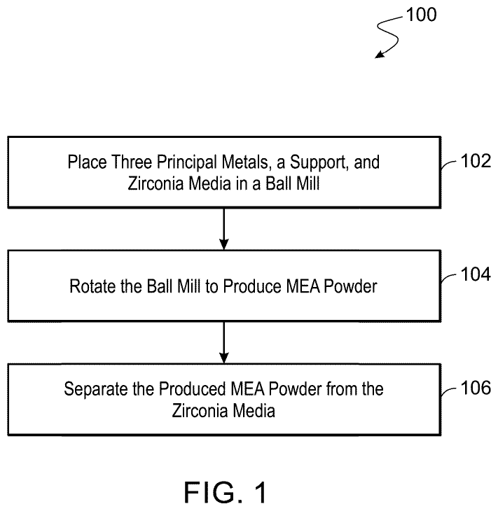

FIG. 1 is a flow chart of an example method 100 of producing a catalyst system of the present disclosure by ball milling. At 102, three principal metals, a support, and zirconia media are placed in a ball mill. In some embodiments, a fourth principal metal is placed in a ball mill. At 104, the ball mill is rotated to produce the catalyst powder. At 106, the produced powder is separated from the zirconia media and collected.

The chemical and physical properties of the synthesized catalyst systems can be investigated with various characterization techniques including X-ray diffraction (XRD), X-ray photoelectron spectroscopy (XPS), scanning electron microscopy (SEM), high-resolution transmission electron microscopy (HRTEM), atomic force microscopy (AFM), energy-dispersive X-ray spectrometry (EDX), BET-surface area, inductively coupled plasma mass spectrometry (ICP-MS), X-ray absorption coefficient, Fourier-transform infrared spectroscopy (FTIR), dynamic light scattering (DLS), UV-vis spectrometry, photoluminescence spectroscopy. In addition, mechanical properties can be analyzed by nanoindentation and dynamical mechanical analysis (e.g., hardness, modulus).

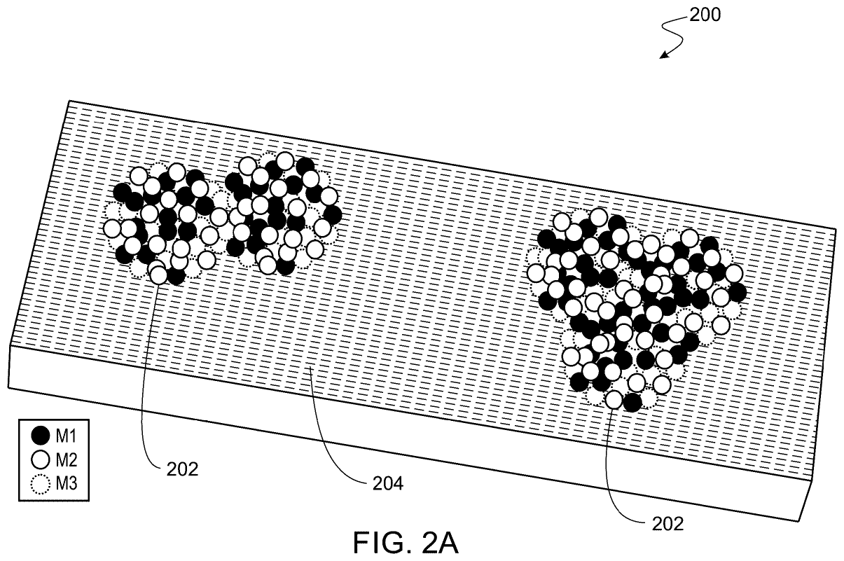

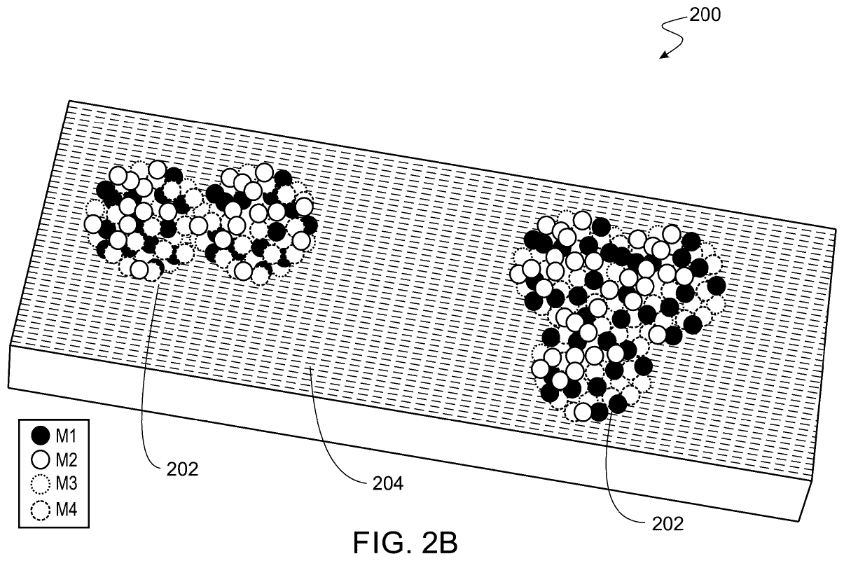

FIG. 2A shows an example schematic of a catalyst system of the present disclosure 200. The catalyst system 200 includes an MEA particle 202 and a support 204. The MEA particle 202 includes three principal metals as described herein. In some embodiments, the MEA particle includes a secondary phase. The support 204 includes metal oxides, mixed oxides, carbon materials or metal organic frameworks, as described herein.

FIG. 2B shows an example schematic of a catalyst system of the present disclosure 200. The catalyst system 200 includes MEA particles 202 and a support 204. The MEA particles 202 include four principal metals as described herein. In some embodiments, the MEA particles include a secondary phase. The support 204 includes metal oxides, mixed oxides, carbon materials or metal organic frameworks, as described herein.

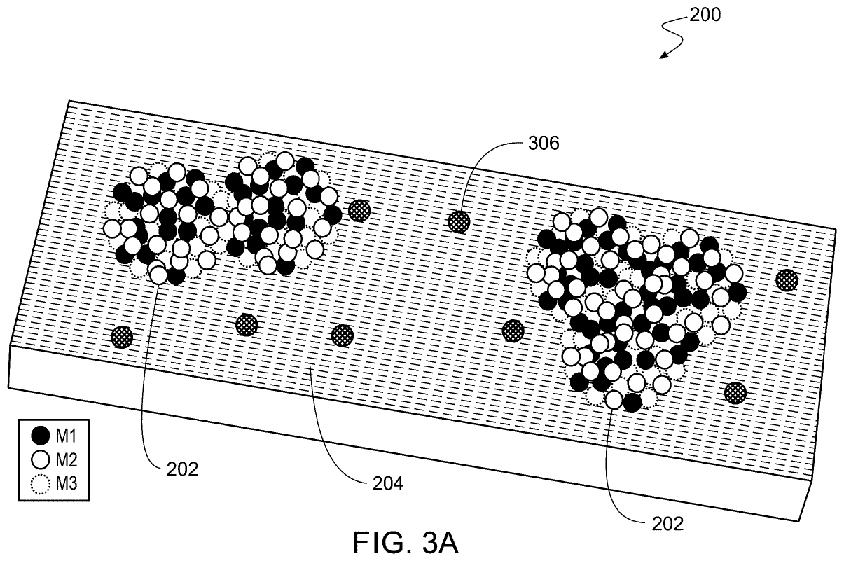

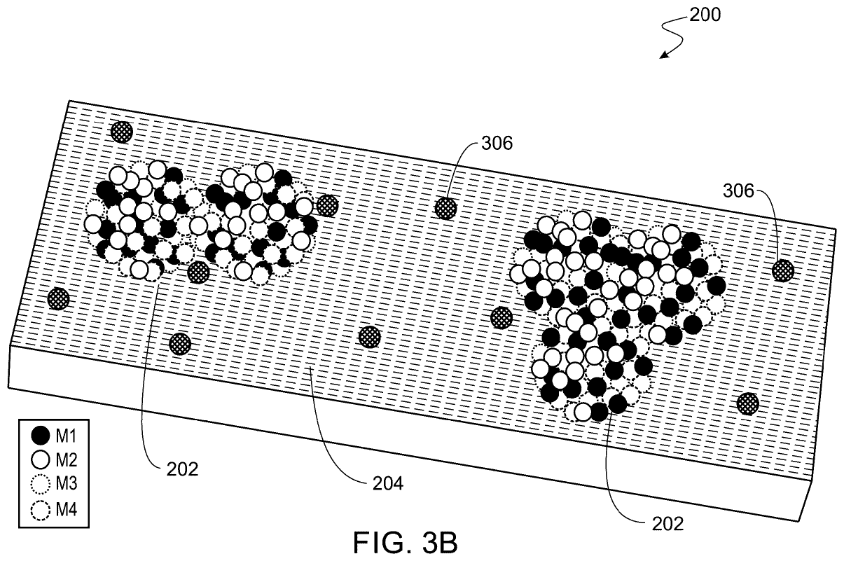

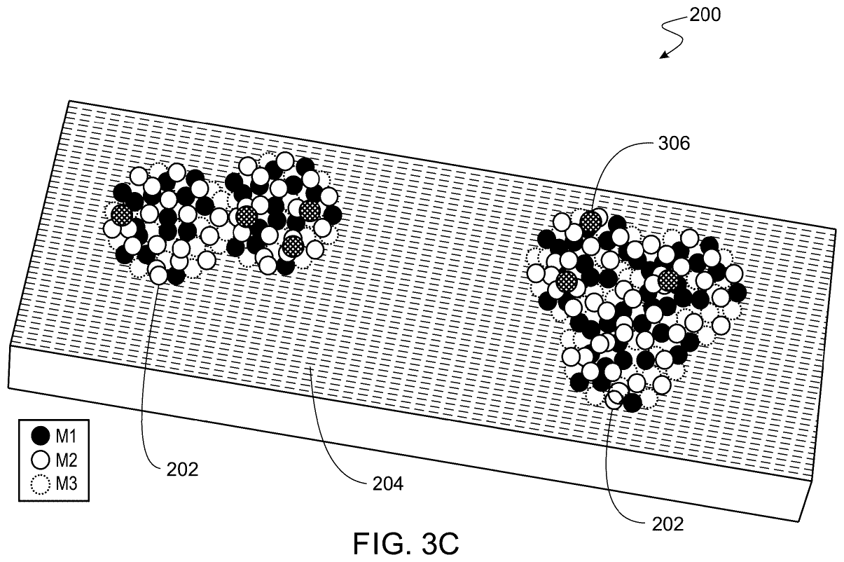

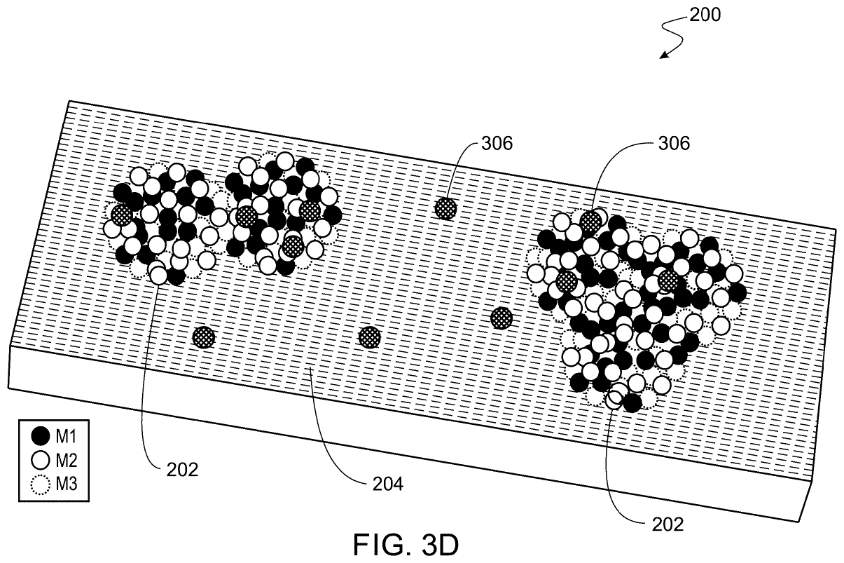

FIG. 3A shows an example schematic of catalyst system of the present disclosure 200, where the MEA particles 202 include three principal metals and where the support 204 includes a catalyst promoter 306. As described herein the catalyst promoter can include alkali metals, Ce, CeₓO_{y} (e.g., Ce₂O₃, and CeO₂), Mg, MgO, Ca₂SiO₄, CaO, La, Nd, Ge, or Re, or any combination thereof.

FIG. 3B shows an example schematic of a catalyst system of the present disclosure 200, where the MEA particles 202 include four principal metals and where the support 204 includes a catalyst promoter 306. FIG. 3C shows another embodiment where the promoter 306 is incorporated in the MEA particle 202. FIG. 3D shows yet another embodiment where the promoter 306 is present on both the support 204 and in the MEA particle 202. The location of the promoter 306 can be tailored by modifying the preparation method. As described herein the catalyst promoter can include alkali metals, Ce, CeₓO_{y} (e.g., Ce₂O₃, and CeO₂), Mg, MgO, Ca₂SiO₄, CaO, La, Nd, Ge, or Re, or any combination thereof.

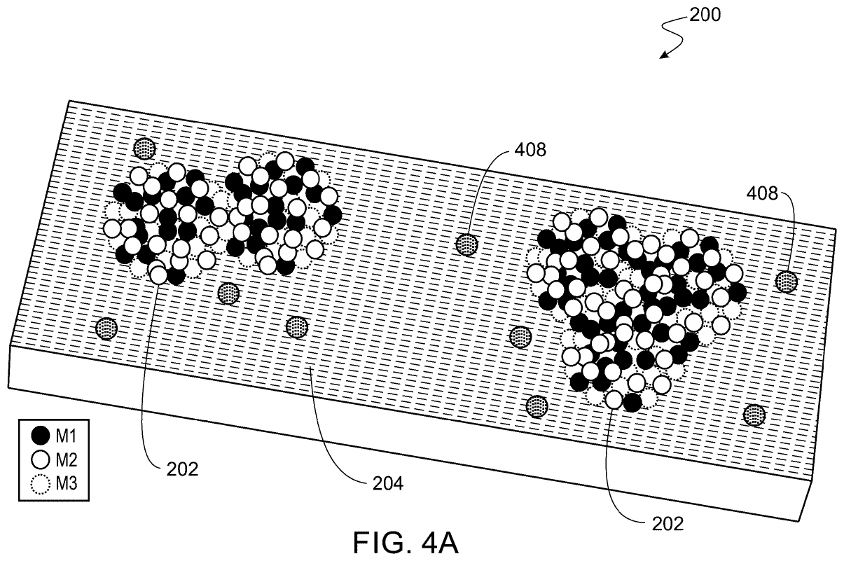

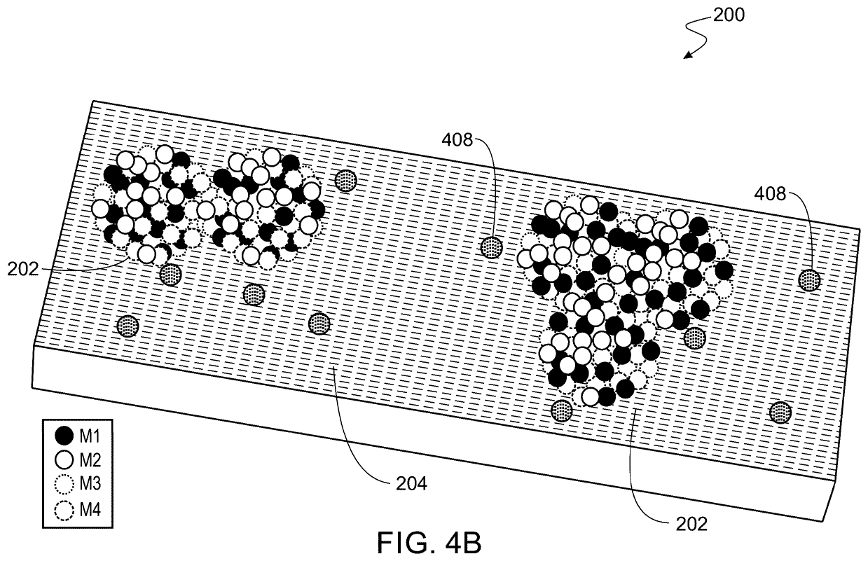

In some embodiments, the catalyst system includes an MEA particle, a support, and defects in the support. FIG. 4A shows an example schematic of a catalyst system of the present disclosure 200 with support defects 408. The catalyst system 200 with support defects 408 includes MEA particles 202 with three principal metals, a support 204, and support defects 408, as described herein.

FIG. 4B shows an example schematic of catalyst system of the present disclosure with support defects 408. The catalyst system 200 with support defects 408 includes MEA particles 202 with four principal metals, a support 204, and support defects 408, as described herein.

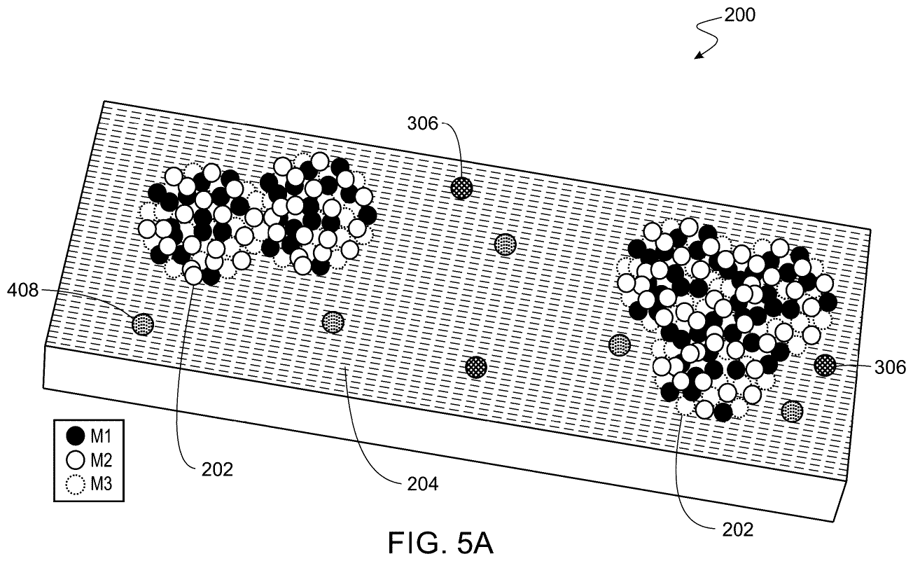

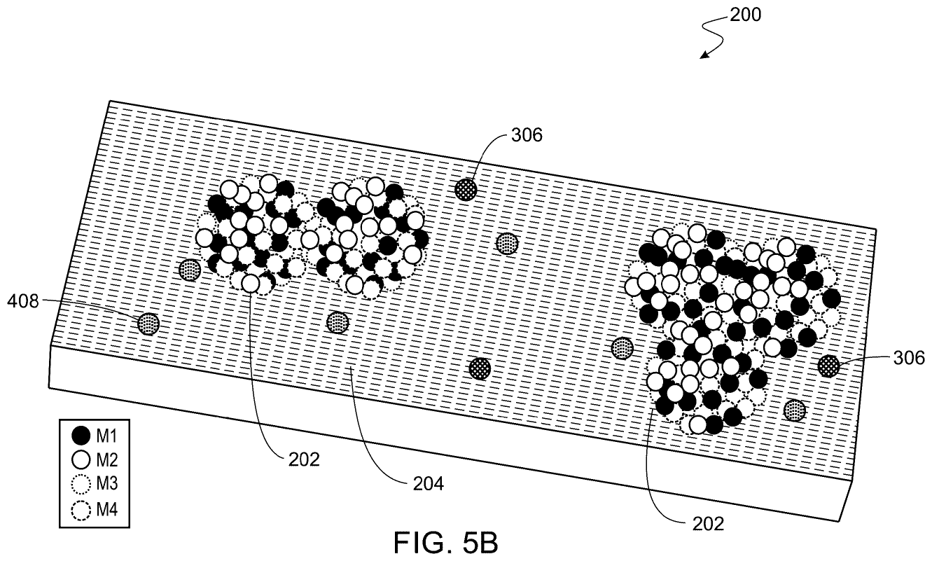

FIG. 5A shows an example of a catalyst system of the present disclosure 200 that includes catalyst promoters 306 and defects 408. The catalyst system includes MEA particles 202 with three principal metals and a support 204, where the support includes defects 408 as well as a catalyst promoter 306.

FIG. 5B shows an example of a catalyst system of the present disclosure 200 that includes catalyst promoters 306 and defects 408. The catalyst system includes MEA particles 202 with four principal metals and a support 204, where the support includes defects 408 as well as a catalyst promoter 306.

### Hydrogen Production Processes

The catalyst system of the present disclosure can be used in hydrogen production processes. In hydrogen production processes, natural gas (methane) or fossil fuels can be used as a feedstock after desulfurization and purification processes. An inert gas, such as N₂, Ar, or a combination thereof can be used as a carrier gas. The feedstock and carrier gas are introduced with appropriate velocity and temperature between about 300° C. and about 1200° C. to the hydrogen production reactor. For example, the feedstock and carrier gas can be introduced at a temperature between about 400° C. and about 1100° C., about 500° C. and about 1000° C., about 600° C. and about 900° C., or about 700 and about 800° C. . . . The feedstock and carrier gas can be heated with conventional heating, induction thermal heating, radiative heating, microwave heating, or heating with renewable energy sources (e.g., solar, wind, geothermal sources) to conduct the hydrogen production reactions.

One type of hydrogen production reaction is methane pyrolysis, also referred to as methane cracking, methane decomposition, or decomposition of methane. Methane pyrolysis can occur in a reactor over catalyst systems as described herein. During this catalyzed reaction the methane decomposes into solid carbon and hydrogen gas, without CO₂ and/or CO emissions.

A method for catalyzing methane pyrolysis includes loading a catalyst system as described herein into a reactor. The reactor is heated, and a feedstock and carrier gas are introduced into the reactor. The feedstock includes methane and the carrier gas includes an inert gas. In some embodiments, the feedstock includes natural gas. In some embodiments, the carrier gas includes N₂, Ar, or a combination thereof. In some embodiments, the feedstock is introduced into the reactor at a velocity of between about 5 mL/min to about 200 mL/min. For example, the feedstock can be introduced into the reactor at a velocity of between about 5 mL/min to about 100 mL/min, at about 5 mL/min to about 50 mL/min, at about 5 mL/min to about 40 mL/min, at about 5 mL/min to about 30 mL/min, about 5 ml/min to about 20 mL/min, or at about 5 mL/min to about 10 mL/min. In some embodiments, the feedstock is introduced into the reactor at a temperature between about 500° C. and about 900° C. at atmospheric pressure. For example, the feedstock can be introduced into the reactor at a temperature between about 600° C. and about 800° C., or at about 700° C.

In some embodiments, the method includes heating the reactor to between about 500° C. and about 1000° C. For example, the method can include heating the reactor to between about 600° C. and about 800° C., or to about 700° C. In some embodiments, the reactor is heated at a rate of about 10° C. per minute.

The method includes catalyzing the pyrolysis of methane in the reactor to produce hydrogen gas. In some embodiments, the produced hydrogen (>99% purity) is simultaneously separated from other components (e.g., unreacted CH₄) using a hydrogen separation membrane system, or is directly used as a hythane fuel (a mixture of hydrogen and methane). In some embodiments, the method includes analyzing the gases produced by the methane pyrolysis reaction using online gas-chromatography equipped with a thermal conductive detector.

Methane pyrolysis also produces a solid carbon byproduct. The solid carbon byproduct can be in the form of amorphous carbon, carbon nanotubes, nanofibers, etc., which have high market value.

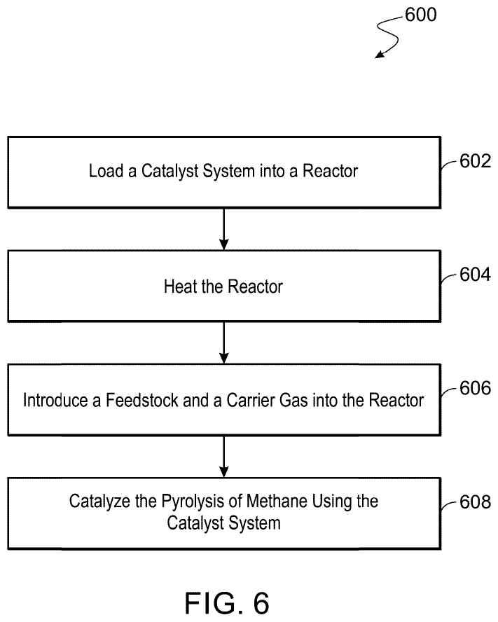

FIG. 6 is a flowchart of an example method of the present disclosure 600 of catalyzing methane pyrolysis. At 602, a catalyst system is loaded into a reactor. The catalyst system includes a medium entropy alloy (MEA) particle, where the MEA particle includes a first principal metal, a second principal metal, and a third principal metal, where each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be. The catalyst system includes a support. The support includes a metal oxide, mixed metal, carbon material, or metal organic framework. At 604, the reactor is heated. At 606, a feedstock and carrier gas are introduced to the reactor. The feedstock includes methane. The carrier gas includes an inert gas. At 608, the pyrolysis of methane is catalyzed using the catalyst system.

Examples 1-3 are related to clean hydrogen production and solid carbon byproduct using the catalyst systems described herein in catalytic methane pyrolysis at elevated temperatures. The produced solid carbon can be amorphous carbon, black carbon, carbon nanotubes, or carbon nanofiber, or a mixture thereof. The support can include metal oxides, mixed metal oxides, and/or carbon materials. Suitable metal oxides include Al₂O₃, SiO₂, TiO₂, ZrO₂, CeO₂, MgO, and MgAl₂O₃, and any combination thereof. Suitable mixed metal oxides include SiO₂—Al₂O₃, ZrO₂—Al₂O₃, CeO₂—Al₂O₃, ZrO₂—TiO₂, CeO₂—TiO₂, ZrO₂—SiO₂, and CeO₂—SiO₂, and any combination thereof. The carbon materials can include carbon nanotubes (CNTs), carbon nanofibers (CNFs), or graphite, or any combination thereof.

### Comparative Example 1—Al₂O₃ Supported FeMn Catalyst

An example catalyst system not encompassed by the wording of the claims was prepared including two principal metals, Fe and Mn. This catalyst system includes an FeMn catalyst and an Al₂O₃ support, and was prepared by ball-milling. 150 g of 3 mm zirconia media, 200 g of 1 mm zirconia media, and the appropriate amount of Fe, Mn, and Al₂O₃ (at a molar ratio of 1:1:1 with a total amount of 50 g) were ball milled at room temperature for 2 days at 1100 rpm. The ball milled Al₂O₃ supported FeMn powder was then separating from the grinding zirconia media and collected. The produced powder was termed FeMn—Al₂O₃. The particle size of this catalyst was 25-100 μm.

About 20 g of FeMn—Al₂O₃ was loaded into a vertical tubular quartz reactor (22 mm inner diameter×25 mm outer diameter×530 mm length with a #4 porosity Frit at 200 mm from the bottom). The quartz tube was closed at both ends by suitable closures that include a gas supply and gas outlet means. Methane was introduced to the system after the reactor reached the reaction temperature, about 700° C. The gas flow of methane was 20 mL/min. The heating rate was 10° C. per minute. The produced hydrogen, unreacted methane, and any other produced gases were analyzed by online gas-chromatography equipped with a thermal conductive detector (TCD).

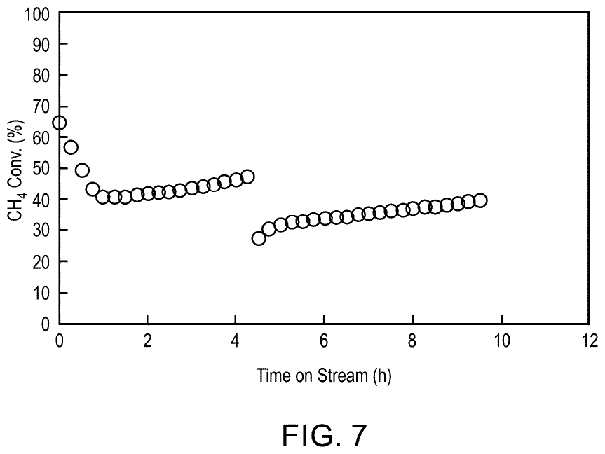

The reaction result in shown in FIG. 7. This catalyst showed an initial methane conversion of about 65%. The conversion reduced to about 41% after 2-2.5 hours of reaction, and then increased and reached a stable level at 47%. After 4.25 hours of reaction, the reactor was cooled down. The same catalyst was used in a reaction again the following day with the same reaction procedure. It was found that the activity of the catalyst was not able to recover in full. The methane conversion rate was initially low, around 28%. The conversion increased gradually at reached about 40% after 5 hours of reaction. The accumulated carbon was about 2.5 g after 10 hours of operation.

### Example 2—Catalyst System Including Al₂O₃ Supported FeMnNi

An Al₂O₃ supported FeMnNi catalyst was prepared by a ball mill method and used to produce clean hydrogen and solid carbon byproducts. Ball-milled Al₂O₃ supported FeMnNi catalysts were prepared by ball milling 150 g of 3 mm zirconia media, 200 g of 1 mm zirconia media, and Fe, Ni, Mn, and Al₂O₃ at a molar ratio of 1:1:1:1 with a total amount of 50 g, for 2 days at room temperature and 1100 rpm. The ball-milled Al₂O₃ supported FeMnNi powder was separated from the grinding zirconia media and collected. The produced powder was termed FeMnNi—Al₂O₃. The particle size of this catalyst was 25-100 μm.

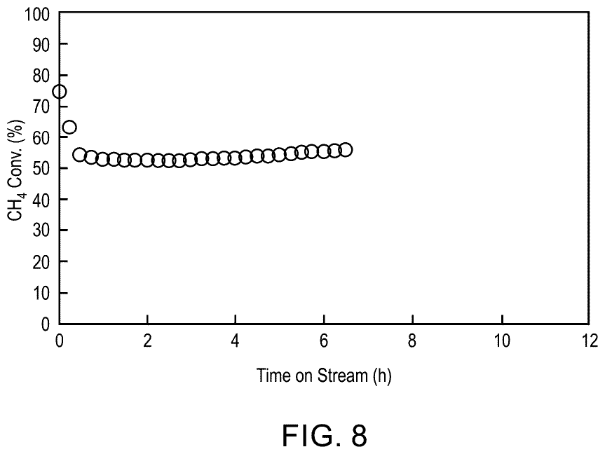

About 20 g of FeMnNi—Al₂O₃ catalyst was loaded into the same reactor and operated at the same conditions as described in Example 1 for hydrogen production via methane pyrolysis at 700° C. The reaction result is shown in FIG. 8. The catalyst showed an initial methane conversion rate of about 75%, which is higher than the initial methane conversion rate of the FeMn—Al₂O₃ catalyst. The conversion of the FeMnNi—Al₂O₃ catalyst dropped to about 53% after 2-2.5 hours of reaction, and then increased to a stable level of about 56%. The accumulated carbon was about 2.3 g after 6.75 hours of operation. This example illustrates that catalysts with three principal metals are more effective than the catalyst with only two principal metals.

### Example 3—Catalyst System Including Al₂O₃ Supported FeMnNiCo

An Al₂O₃ supported FeMnNiCo catalyst was prepared by a ball mill method and used to produce clean hydrogen and solid carbon byproducts.

Ball-milled Al₂O₃ supported FeMnNiCo catalysts were prepared by ball milling 150 g of 3 mm zirconia media, 200 g of 1 mm zirconia media, and the appropriate amount of Fe, Co, Mn, Ni, and Al₂O₃ at a molar ratio of 1:1:1:1:1 for a total amount of 50 g, in a ball mill at room temperature for 2 days at 1100 rpm. The ball-milled Al₂O₃ support FeMnNiCo powder was separated from the grinding zirconia media and collected. The produced powder was termed FeMnNiCo-Al₂O₃. The particle size of these catalysts was between 25-100 μm.

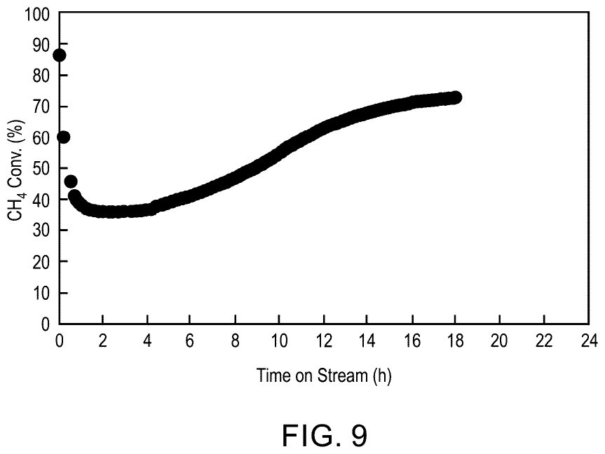

About 20 g of FeMnNiCo—Al₂O₃ catalyst was loaded into the same reactor and operated at the same conditions as described in Example 1 for hydrogen production via methane pyrolysis at 700° C. The reaction result is shown in FIG. 9. The FeMnNiCo—Al₂O₃ catalyst shows a very good initial methane conversion rate of about 88%. The conversion rate dropped to about 36% after 2 hours, and then maintained at that level for another 2 hours. The methane conversion rate then went up and reached a stable level of about 73%. The accumulated carbon over the FeMnNiCo—Al₂O₃ catalyst was about 3.7 g after 18 hours of operation.

For each of Examples 1-3, the process generates solid carbon byproducts that are the mixture of carbon black, carbon nanotubes, and carbon nanofiber. The amount of produced carbon depends on various parameters such as the flow rate of carbon feedstock, composition of carbon feedstock, reaction time, amount of catalyst, and other factors.

### Definitions

The term “about” as used in this disclosure can allow for a degree of variability in a value or range, for example, within 10%, within 5%, or within 1% of a stated value or of a stated limit of a range.

The term “room temperature” as used in this disclosure refers to a temperature of about 15 degrees Celsius (° C.) to about 28° C.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

As used in this disclosure, “atomic percent” (at %) can be considered an atomic fraction or atomic ratio of a substance to the total mixture or composition. Atomic percent can be an atom-to-atom ratio or mole-to-mole ratio, unless indicated otherwise.

A number of embodiments of the disclosure have been described. Nevertheless, it will be understood that various modifications may be made without departing from the spirit and scope of the disclosure.

### Embodiments

1. A catalyst system comprising:
a medium entropy alloy (MEA) particle, wherein the MEA particle comprises
   a first principal metal,
   a second principal metal, and
   a third principal metal, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be; and
a support, wherein the support comprises a metal oxide, mixed oxide, carbon material, or metal organic framework.

2. The catalyst system of embodiment 1, wherein the support comprises a metal oxide, and wherein the metal oxide is selected from the group consisting of Al₂O₃, SiO₂, TiO₂, ZrO₂, CeO₂, MgO, and MgAl₂O₃, and any combination thereof.

3. The catalyst system of embodiment 1 or 2, wherein the support comprises a mixed oxide, wherein the mixed oxide is selected from the group consisting of SiO₂—Al₂O₃, ZrO₂—Al₂O₃, CeO₂—Al₂O₃, ZrO₂—TiO₂, CeO₂—TiO₂, ZrO₂—SiO₂, and CeO₂—SiO₂, and any combination thereof.

4. The catalyst system of any one of embodiments 1-3, wherein the first principal metal is Fe, the second principal metal is Mn, and the third principal metal is Ni.

5. The catalyst system of embodiments 1-4, wherein the support comprises Al₂O₃.

6. The catalyst system of any one of embodiments 1-5, wherein the amount of each principal metal in the MEA particle is between 10 atomic percent (at %) and 40 at %.

7. The catalyst system of any one of embodiments 1-6, wherein each principal metal is present in the MEA particle at an approximately equimolar amount.

8. The catalyst system of any one of embodiments 1-7, wherein the MEA particle is from about 1 nm to about 10 μm in diameter.

9. The catalyst system of any one of embodiments 1-8, wherein the MEA particle comprises a secondary phase, and wherein the secondary phase is intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite, or any combination thereof.

10. The catalyst system of any one of embodiments 1-9, further comprising a promoter, wherein the promoter is selected from the group consisting of Li, Na, Ca, K, Cs, Fr, Ce, Ce₂O₃, CeO₂, Mg, MgO, Ca₂SiO₄, CaO, La, Nd, Ge, or Re, or any combination thereof.

11. The catalyst system of any one of embodiments 1-10, wherein the support comprises defects, wherein the defects are surface atom vacancy, surface heteroatomic bonding, structure distortion, surface step, edge defects, stacking fault, or holes, or any combination thereof.

12. The catalyst system of any one of embodiments 1-11, wherein the MEA particle further comprises a fourth principal metal, wherein the fourth principal metal is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be.

13. The catalyst system of any one of embodiments 1-12, wherein the support

comprises a metal oxide, and wherein the metal oxide is selected from the group consisting of Al₂O₃, SiO₂, TiO₂, ZrO₂, CeO₂, MgO, and MgAl₂O₃, and any combination thereof.

14. The catalyst system of any one of embodiments 1-13, wherein the support comprises a mixed oxide, wherein the mixed oxide is selected from the group consisting of SiO₂—Al₂O₃, ZrO₂—Al₂O₃, CeO₂—Al₂O₃, ZrO₂—TiO₂, CeO₂—TiO₂, ZrO₂—SiO₂, and CeO₂—SiO₂, and any combination thereof.

15. The catalyst system of any one of embodiments 12-14, wherein the first principal metal is Fe, the second principal metal is Mn, the third principal metal is Ni, and the fourth principal metal is Co.

16. The catalyst system of any one of embodiments 1-15, wherein the support comprises Al₂O₃.

17. The catalyst system of any one of embodiments 1-16, wherein the amount of each principal metal in the MEA particle is between 10 atomic percent (at %) and 40 at %.

18. The catalyst system of any one of embodiments 1-17, wherein each principal metal is present in the MEA particle at an approximately equimolar amount.

19. The catalyst system of any one of embodiments 1-18, wherein the MEA particle is from about 1 nm to about 10 μm in diameter.

20. The catalyst system of any one of embodiments 1-19, wherein the MEA particle comprises a secondary phase, and wherein the secondary phase is intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite, or any combination thereof.

21. The catalyst system of any one of embodiments 1-20, further comprising a promoter, wherein the promoter is selected from the group consisting of Li, Na, Ca, K, Cs, Fr, Ce, Ce₂O₃, CeO₂, Mg, MgO, Ca₂SiO₄, CaO, La, Nd, Ge, or Re, or any combination thereof.

22. The catalyst system of any one of embodiments 1-21, wherein the support comprises defects, wherein the defects are surface atom vacancy, surface heteroatomic bonding, structure distortion, surface step, edge defects, stacking fault, or holes, or any combination thereof.

23. A method of producing a catalyst system, the method comprising:
placing a first principal metal, a second principal metal, and a third principal metal, a support, and zirconia media in a ball mill, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be, and wherein the support comprises a metal oxide, mixed oxide, carbon material, or metal organic framework;
rotating the ball mill to produce the catalyst system; and
separating the produced catalyst system from the zirconia media.

24. The method of embodiment 23, wherein the first metal principal metal is Fe, the second principal metal is Mn, the third principal metal is Ni, and the support comprises Al₂O₃.

25. The method of embodiment 23 or 24, further comprising placing a fourth principal metal in the ball mill before rotating the ball mill, wherein the fourth principal metal is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be.

26. The method of embodiment 25, wherein the first principal metal is Fe, the second principal metal is Mn, the third principal metal is Ni, the fourth principal metal is Co, and the support comprises Al₂O_{3.}

27. The method of any one of embodiments 23-26, wherein the ball mill is rotated for about 2 days at about 1100 rpm.

28. The method of one of embodiments 23-27, further comprising placing a secondary phase in the ball mill before rotating the ball mill, wherein the secondary phase comprises intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite, or any combination thereof.

29. The method of one of embodiments 23-28, wherein the zirconia media comprises zirconia particles with a diameter of about 1 mm and zirconia particles with a diameter of about 3 mm.

30. A method of catalyzing methane pyrolysis, the method comprising:
loading a catalyst system into a reactor, wherein the catalyst system comprises
   a medium entropy alloy (MEA) particle, wherein the MEA particle comprises
      a first principal metal,
      a second principal metal, and
      a third principal metal, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be, and
   a support, wherein the support comprises a metal oxide, mixed oxide, carbon material, or metal organic framework;
heating the reactor;
introducing a feedstock and a carrier gas to the reactor, wherein the feedstock comprises methane and wherein the carrier gas comprises an inert gas; and
catalyzing the pyrolysis of the methane using the catalyst system to produce hydrogen gas.

31. The method of embodiment 30, wherein the MEA particle further comprises a fourth principal metal, wherein the fourth principal metal is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be.

32. The method of embodiment 30 or 31, wherein the support comprises a metal oxide, and wherein the metal oxide is selected from the group consisting of Al₂O₃, SiO₂, TiO₂, ZrO₂, CeO₂, MgO, and MgAl₂O₃, and any combination thereof.

33. The method of any one of embodiments 30-32, wherein the support comprises a mixed oxide, wherein the mixed oxide is selected from the group consisting of SiO₂—Al₂O₃, ZrO₂—Al₂O₃, CeO₂—Al₂O₃, ZrO₂—TiO₂, CeO₂—TiO₂, ZrO₂—SiO₂, and CeO₂—SiO₂, and any combination thereof.

34. The method of any one of embodiments 30-33, wherein the support comprises a carbon materials, and wherein the carbon materials are selected from the group consisting of amorphous carbon, carbon black, activated carbon, graphene, graphene oxide, carbon nanotubes (CNTs), carbon nanofibers (CNFs), and graphite, and any combination thereof.

35. The method of any one of embodiments 30-34, wherein the first principal metal is Fe, the second principal metal is Mn, the third principal metal is Ni, and the support comprises Al₂O₃.

36. The method of any one of embodiments 31-35, wherein the first principal metal is Fe, the second principal metal is Mn, the third principal metal is Ni, the fourth principal metal is Co, and the support comprises Al₂O₃.

37. The method of any one of embodiments 30-36, wherein the

feedstock comprises natural gas.

38. The method of any one of embodiments 30-37, wherein the carrier gas comprises N₂, Ar, or a combination thereof.

39. The method of any one of embodiments 30-38, wherein the feedstock is introduced into the reactor at a velocity of between about 5 mL/min to about 200 mL/min.

40. The method of any one of embodiments 30-39, wherein the feedstock is introduced to the reactor at a temperature between about 500° C. and about 900° C.

41. The method of any one of embodiments 30-40, wherein the feedstock is introduced to the reactor at atmospheric pressure.

42. The method of any one of embodiments 30-41, wherein heating the reactor comprises heating the reactor to between about 500° C. and about 1000° C.

43. The method of any one of embodiments 30-42, wherein heating the reactor comprises heating the reactor to about 700° C.

44. The method of any one of embodiments 30-43, wherein heating the reactor comprises heating the reactor at a rate of about 10° C. per minute.

45. The method of any one of embodiments 30-44, further comprising analyzing the gases produced by the methane pyrolysis using online gas-chromatography equipped with a thermal conductive detector.

46. The method of any one of embodiments 30-45, further comprising separating the produced hydrogen gas using a hydrogen separation membrane.

What is claimed is:

1. A catalyst system comprising:
a medium entropy alloy (MEA) particle, wherein the MEA particle comprises
a first principal metal,
a second principal metal, and
a third principal metal, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be; and
a support, wherein the support comprises a metal oxide, mixed oxide, carbon material, or metal organic framework.

2. The catalyst system of claim 1, wherein the support comprises a metal oxide, and wherein the metal oxide is selected from the group consisting of Al₂O₃, SiO₂, TiO₂, ZrO₂, CeO₂, MgO, and MgAl₂O₃, and any combination thereof.

3. The catalyst system of claim 1, wherein the support comprises a mixed oxide, wherein the mixed oxide is selected from the group consisting of SiO₂—Al₂O₃, ZrO₂—Al₂O₃, CeO₂—Al₂O₃, ZrO₂—TiO₂, CeO₂—TiO₂, ZrO₂—SiO₂, and CeO₂—SiO₂, and any combination thereof.

4. The catalyst system of claim 1, wherein the first principal metal is Fe, the second principal metal is Mn, and the third principal metal is Ni.

5. The catalyst system of claim 2, wherein the support comprises Al₂O₃.

6. The catalyst system of claim 1, wherein the amount of each principal metal in the MEA particle is between 10 atomic percent (at %) and 40 at %.

7. The catalyst system of claim 1, wherein each principal metal is present in the MEA particle at an approximately equimolar amount.

8. The catalyst system of claim 1, wherein the MEA particle is from about 1 nm to about 10 μm in diameter.

9. The catalyst system of claim 1, wherein the MEA particle comprises a secondary phase, and wherein the secondary phase is intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite, or any combination thereof.

10. The catalyst system of claim 1, further comprising a promoter, wherein the promoter is selected from the group consisting of Li, Na, Ca, K, Cs, Fr, Ce, Ce₂O₃, CeO₂, Mg, MgO, Ca₂SiO₄, CaO, La, Nd, Ge, or Re, or any combination thereof.

11. The catalyst system of claim 1, wherein the support comprises defects, wherein the defects are surface atom vacancy, surface heteroatomic bonding, structure distortion, surface step, edge defects, stacking fault, or holes, or any combination thereof.

12. The catalyst system of claim 1, wherein the MEA particle further comprises a fourth principal metal, wherein the fourth principal metal is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be.

13. The catalyst system of claim 12, wherein the support comprises a metal oxide, and wherein the metal oxide is selected from the group consisting of Al₂O₃, SiO₂, TiO₂, ZrO₂, CeO₂, MgO, and MgAl₂O₃, and any combination thereof.

14. The catalyst system of claim 12, wherein the support comprises a mixed oxide, wherein the mixed oxide is selected from the group consisting of SiO₂13 Al₂O₃, ZrO₂—Al₂O₃, CeO₂—Al₂O₃, ZrO₂—TiO₂, CeO₂—TiO₂, ZrO₂—SiO₂, and CeO₂—SiO₂, and any combination thereof.

15. The catalyst system of claim 12, wherein the first principal metal is Fe, the second principal metal is Mn, the third principal metal is Ni, and the fourth principal metal is Co.

16. The catalyst system of claim 15, wherein the support comprises Al₂O₃.

17. The catalyst system of claim 12, wherein the amount of each principal metal in the MEA particle is between 10 atomic percent (at %) and 40 at %.

18. The catalyst system of claim 12, wherein each principal metal is present in the MEA particle at an approximately equimolar amount.

19. The catalyst system of claim 12, wherein the MEA particle is from about 1 nm to about 10 μm in diameter.

20. The catalyst system of claim 12, wherein the MEA particle comprises a secondary phase, and wherein the secondary phase is intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite, or any combination thereof.

21. The catalyst system of claim 12, further comprising a promoter, wherein the promoter is selected from the group consisting of Li, Na, Ca, K, Cs, Fr, Ce, Ce₂O₃, CeO₂, Mg, MgO, Ca₂SiO₄, CaO, La, Nd, Ge, or Re, or any combination thereof.

22. The catalyst system of claim 12, wherein the support comprises defects, wherein the defects are surface atom vacancy, surface heteroatomic bonding, structure distortion, surface step, edge defects, stacking fault, or holes, or any combination thereof.

23. A method of producing a catalyst system, the method comprising:
placing a first principal metal, a second principal metal, and a third principal metal, a support, and zirconia media in a ball mill, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be, and wherein the support comprises a metal oxide, mixed oxide, carbon material, or metal organic framework;
rotating the ball mill to produce the catalyst system; and
separating the produced catalyst system from the zirconia media.

24. The method of claim 23, wherein the first metal principal metal is Fe, the second principal metal is Mn, the third principal metal is Ni, and the support comprises Al₂O₃.

25. The method of claim 23, further comprising placing a fourth principal metal in the ball mill before rotating the ball mill, wherein the fourth principal metal is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be.

26. The method of claim 25, wherein the first principal metal is Fe, the second principal metal is Mn, the third principal metal is Ni, the fourth principal metal is Co, and the support comprises Al₂O₃.

27. The method of claim 23, wherein the ball mill is rotated for about 2 days at about 1100 rpm.

28. The method of claim 23, further comprising placing a secondary phase in the ball mill before rotating the ball mill, wherein the secondary phase comprises intermetallic, laves phases, carbide, borides, borocarbides, nitrides, silicide, aluminides, oxides, phosphides, phosphates, sulfides, sulfates, hydrides, hydrates, carbonitrides, graphene, graphene oxide, nanotubes, or graphite, or any combination thereof.

29. The method of claim 23, wherein the zirconia media comprises zirconia particles with a diameter of about 1 mm and zirconia particles with a diameter of about 3 mm.

30. A method of catalyzing methane pyrolysis, the method comprising:
loading a catalyst system into a reactor, wherein the catalyst system comprises
a medium entropy alloy (MEA) particle, wherein the MEA particle comprises
a first principal metal,
a second principal metal, and
a third principal metal, wherein each of the principal metals is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be, and
a support, wherein the support comprises a metal oxide, mixed oxide, carbon material, or metal organic framework;
heating the reactor;
introducing a feedstock and a carrier gas to the reactor, wherein the feedstock comprises methane and wherein the carrier gas comprises an inert gas; and
catalyzing the pyrolysis of the methane using the catalyst system to produce hydrogen gas.

31. The method of claim 30, wherein the MEA particle further comprises a fourth principal metal, wherein the fourth principal metal is independently selected without repetition from the group consisting of Ag, Au, Co, Cr, Cu, Fe, Ir, Mn, Mo, Ni, Pd, Pt, Re, Rh, Ru, Sn, Ti, V, W, Y, Zn, Zr, Al, Ga, In, Ce, Yb, and Be.

32. The method of claim 30, wherein the support comprises a metal oxide, and wherein the metal oxide is selected from the group consisting of Al₂O₃, SiO₂, TiO₂, ZrO₂, CeO₂, MgO, and MgAl₂O₃, and any combination thereof.

33. The method of claim 30, wherein the support comprises a mixed oxide, wherein the mixed oxide is selected from the group consisting of SiO₂—Al₂O₃, ZrO₂—Al₂O₃, CeO₂—Al₂O₃, ZrO₂—TiO₂, CeO₂—TiO₂, ZrO₂—SiO₂, and CeO₂—SiO₂, and any combination thereof.

34. The method of claim 30, wherein the support comprises a carbon materials, and wherein the carbon materials are selected from the group consisting of amorphous carbon, carbon black, activated carbon, graphene, graphene oxide, carbon nanotubes (CNTs), carbon nanofibers (CNFs), and graphite, and any combination thereof.

35. The method of claim 30, wherein the first principal metal is Fe, the second principal metal is Mn, the third principal metal is Ni, and the support comprises Al₂O₃.

36. The method of claim 31, wherein the first principal metal is Fe, the second principal metal is Mn, the third principal metal is Ni, the fourth principal metal is Co, and the support comprises Al₂O₃.

37. The method of claim 30, wherein the feedstock comprises natural gas.

38. The method of claim 30, wherein the carrier gas comprises N₂, Ar, or a combination thereof.

39. The method of claim 30, wherein the feedstock is introduced into the reactor at a velocity of between about 5 mL/min to about 200 mL/min.

40. The method of claim 30, wherein the feedstock is introduced to the reactor at a temperature between about 500° C. and about 900° C.

41. The method of claim 30, wherein the feedstock is introduced to the reactor at atmospheric pressure.

42. The method of claim 30, wherein heating the reactor comprises heating the reactor to between about 500° C. and about 1000° C.

43. The method of claim 30, wherein heating the reactor comprises heating the reactor to about 700° C.

44. The method of claim 30, wherein heating the reactor comprises heating the reactor at a rate of about 10° C. per minute.

45. The method of claim 30, further comprising analyzing the gases produced by the methane pyrolysis using online gas-chromatography equipped with a thermal conductive detector.

46. The method of claim 30, further comprising separating the produced hydrogen gas using a hydrogen separation membrane.
